(19) United States
(12) Patent Application Publication
(10) Pub. No.: US 2026/0328127 A1
(43) Pub. Date: Oct. 22, 2026

(54) EXHAUST TREATMENT DEVICE

(71) Applicant: ISUZU MOTORS LIMITED, Yokohama-shi (JP)

(72) Inventors: Junji SAKAI, Fujisawa-shi (JP); Atsushi IGARASHI, Fujisawa-shi (JP); Kazuho YOSHIDA, Fujisawa-shi (JP)

(21) Appl. No.: 19/551,663

(22) Filed: Feb. 27, 2026

(30) Foreign Application Priority Data
Apr. 17, 2025 (JP) 2025-067933

(51) Int. Cl. F01N 3/20; B01D 53/34; B01D 53/94; F01N 3/28

(52) U.S. Cl. CPC F01N 3/208; B01D 53/346; B01D 53/9431; F01N 3/2892; B01D 2251/2067; B01D 2257/404; B01D 2258/01; F01N 2610/02; F01N 2900/1402

(57) ABSTRACT

An exhaust treatment device includes a conduit that guides exhaust gas introduced from an inlet port formed in an outer peripheral surface to the outside of the exhaust pipe, a partition portion that divides a circumference of the conduit into a first region and a second region in a circumferential direction, and in which a communication port that allows exhaust gas to move from the first region to the second region is formed, a guide plate that is provided in the second region along an outer peripheral surface of the conduit, and guides exhaust gas to the inlet port, a NOx sensor that detects concentration of NOx in exhaust gas in the first region, and an injection unit that injects urea water toward the guide plate.

### CROSS-REFERENCE TO RELATED APPLICATIONS

The present application claims priority to Japanese Patent Applications number 2025-67933, filed on Apr. 17, 2025 contents of which are incorporated herein by reference in their entirety.

### BACKGROUND OF THE INVENTION

The present disclosure relates to an exhaust treatment device that purifies exhaust gas.

Japanese Unexamined Patent Application Publication No. 2012-47109 discloses a technique in which a cylindrical adhesion-prevention member is provided in an exhaust pipe to separate a NOx sensor from an injection unit, in order to suppress adhesion of the urea water injected by the injection unit to the NOx sensor in the exhaust pipe through which exhaust gas flows. Further, a dispersion member for evaporating and decomposing urea water is provided inside the adhesion-prevention member.

However, in the above-described technique, although urea water adhering to the dispersion member can be evaporated and decomposed by heat of exhaust gas, an injection direction of urea water is orthogonal to a flow of the exhaust gas, which makes it difficult for the urea water to flow. As a result, the urea water cannot be efficiently hydrolyzed by the heat of the exhaust gas.

### BRIEF SUMMARY OF THE INVENTION

The present disclosure focuses on this point, and an object thereof is to suppress adhesion of urea water to a NOx sensor while promoting evaporation and decomposition of the urea water.

### MEANS FOR SOLVING THE PROBLEMS

An aspect of the present disclosure provides an exhaust treatment device including an exhaust pipe through which exhaust gas flows, a pair of plate members that are provided to face each other with a predetermined spacing therebetween in an axial direction of the exhaust pipe, and form a space in the exhaust pipe, a conduit that is provided in the space along the axial direction, and guides exhaust gas introduced from an inlet port formed in an outer peripheral surface to the outside of the exhaust pipe, a partition portion that divides a circumference of the conduit into a first region and a second region in a circumferential direction, and in which a communication port that allows exhaust gas to move from the first region to the second region is formed, a guide plate that is provided in the second region along an outer peripheral surface of the conduit, and guides exhaust gas to the inlet port, a NOx sensor that detects concentration of NOx in exhaust gas in the first region, and an injection unit that injects urea water toward the guide plate in the second region.

### BRIEF DESCRIPTION OF THE DRAWINGS

FIG. 1 schematically shows a configuration of an exhaust treatment device 1 according to an embodiment.

FIG. 2 schematically shows an internal configuration of an exhaust pipe 16.

FIG. 3 schematically shows the exhaust pipe 16 as viewed from an upstream plate 30 side.

FIG. 4 schematically shows the exhaust pipe 16 as viewed from a downstream plate 40 side.

FIG. 5 schematically shows a cross-sectional configuration of the exhaust pipe 16 taken along a cross section orthogonal to an axial direction.

FIG. 6 schematically shows a mode in which exhaust gas flowing in through a second inflow hole 33 is directed to an inlet port 47.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure. 13

### Configuration of Exhaust Treatment Device

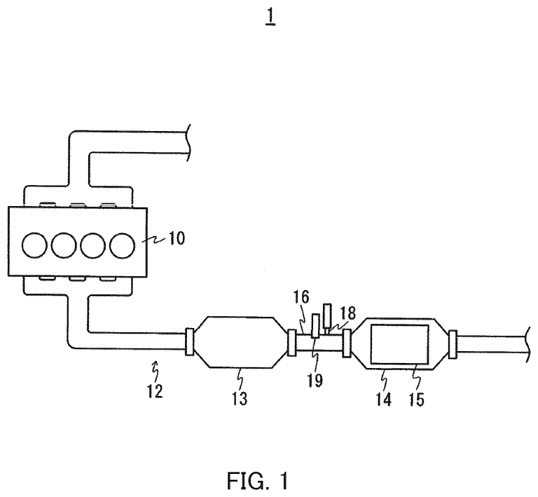

FIG. 1 schematically shows a configuration of an exhaust treatment device 1 according to an embodiment. As shown in FIG. 1, the exhaust treatment device 1 includes an engine 10, an exhaust passage 12, an upstream aftertreatment unit 13, a downstream aftertreatment unit 14, an exhaust pipe 16, an injection unit 18, and a NOx sensor 19. The exhaust treatment device 1 is mounted on a vehicle such as a truck as an example, and purifies exhaust gas from the engine 10.

The engine 10 is an internal combustion engine that generates power by combusting and expanding a mixture of fuel and intake air. The engine 10 is a diesel engine, for example.

The exhaust passage 12 is connected to the engine 10 and discharges exhaust gas from the engine 10. The upstream aftertreatment unit 13, the downstream aftertreatment unit 14, the exhaust pipe 16, the injection unit 18, and the NOx sensor 19 are provided in the exhaust passage 12.

The upstream aftertreatment unit 13 includes a catalyst that purifies Particulate Matter (PM) contained in exhaust gas. The catalyst includes a filter that collects PM, for example. The filter is formed of a honeycomb body made of metal or ceramics, for example, and collects PM by pores and surfaces of partition walls.

The downstream aftertreatment unit 14 is a device that converts NOx in exhaust gas into harmless nitrogen through reduction reaction. The downstream aftertreatment unit 14 includes a reduction catalyst 15 that promotes the reduction reaction of NOx with ammonia. Ammonia generated from urea water is adsorbed to the reduction catalyst 15. The reduction catalyst 15 reduces NOx to nitrogen and water using the adsorbed ammonia, thereby reducing NOx emissions.

The exhaust pipe 16 is a pipe connecting the upstream aftertreatment unit 13 and the downstream aftertreatment unit 14, and the exhaust gas that has passed through the upstream aftertreatment unit 13 flows to the downstream aftertreatment unit 14 through the exhaust pipe 16. In the exhaust pipe 16, ammonia gas is generated from the urea water injected by the injection unit 18. A detailed configuration of the exhaust pipe 16 will be described later.

The injection unit 18 is provided in the exhaust pipe 16, and injects urea water into the exhaust pipe 16. The urea water injected by the injection unit 18 is evaporated and decomposed by heat of the exhaust gas flowing through the exhaust pipe 16 to generate ammonia. The ammonia is used to cause reduction reaction of NOx in the exhaust gas.

The NOx sensor 19 is provided in the exhaust pipe 16, and detects the concentration of NOx in exhaust gas. Specifically, the NOx sensor 19 detects the concentration of NOx in the exhaust gas flowing through the exhaust pipe 16. The concentration of NOx detected by the NOx sensor 19 is used to control an injection amount of urea water by the injection unit 18. For example, the injection unit 18 increases the injection amount of urea water as the concentration of NOx becomes larger.

### Detailed Configuration Exhaust Pipe 16

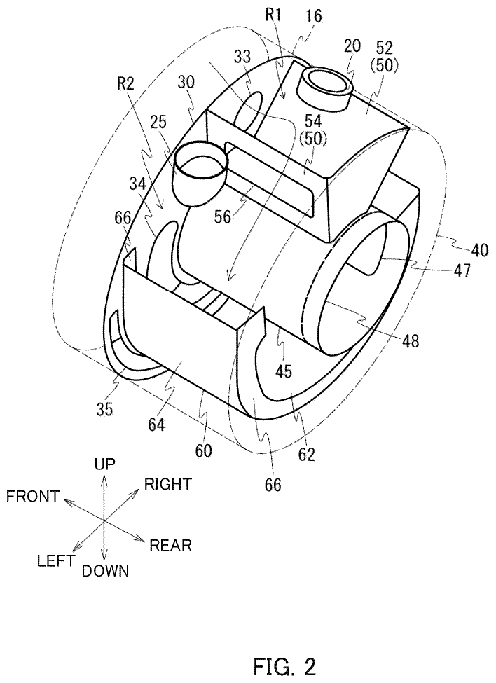

A detailed configuration of the exhaust pipe 16 will be described with reference to FIG. 2 to FIG. 6.

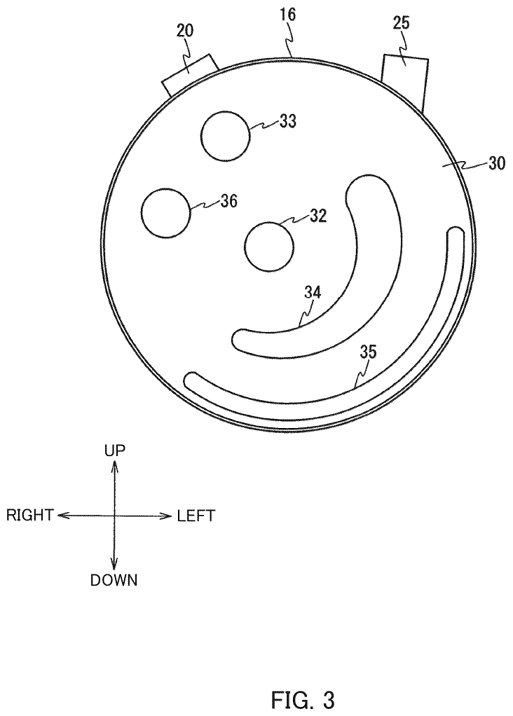

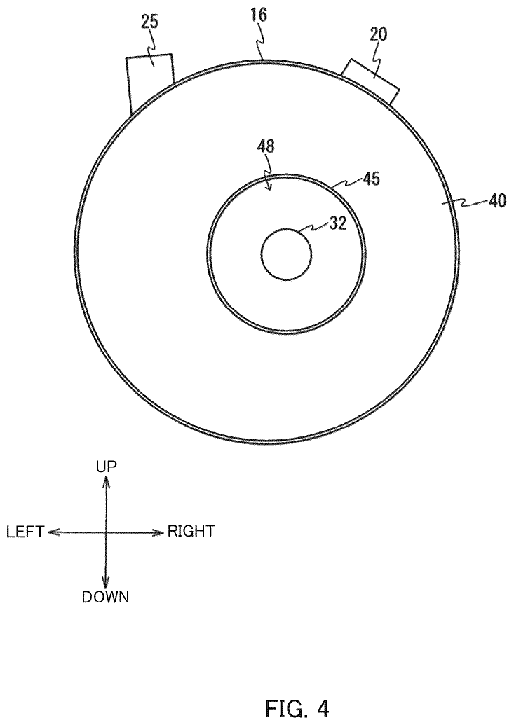

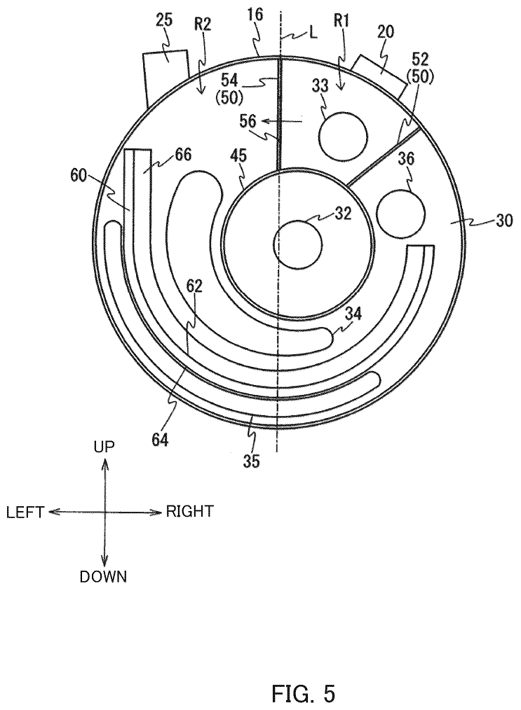

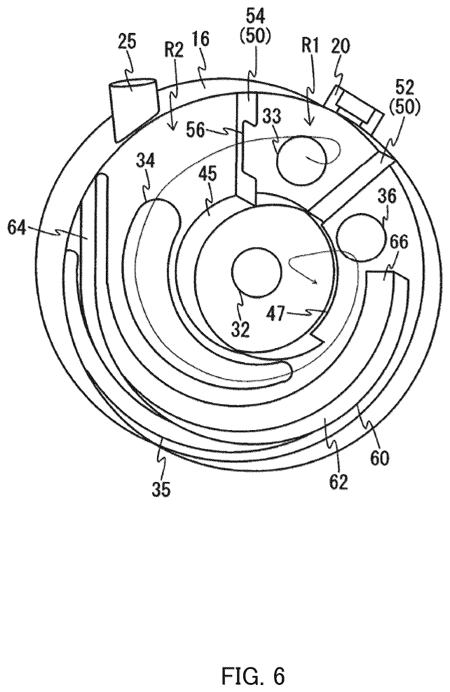

FIG. 2 schematically shows an internal configuration of the exhaust pipe 16. FIG. 3 schematically shows the exhaust pipe 16 as viewed from an upstream plate 30 side. FIG. 4 schematically shows the exhaust pipe 16 as viewed from a downstream plate 40 side. FIG. 5 schematically shows a cross-sectional configuration of the exhaust pipe 16 taken along a cross section orthogonal to an axial direction. FIG. 6 schematically shows a mode in which exhaust gas flowing in through a second inflow hole 33 is directed to an inlet port 47. It should be noted that, in FIG. 2, the exhaust pipe 16 and the downstream plate 40 are indicated by broken lines to facilitate understanding of the internal configuration. In FIG. 2 to FIG. 6, the injection unit 18 and the NOx sensor 19 are omitted for convenience of description. Arrows shown in FIG. 2, FIG. 5, and FIG. 6 indicate a flow of exhaust gas. Further, “front” shown in FIG. 2 means an upstream side of the exhaust pipe 16, and “rear” shown in FIG. 2 means a downstream side of the exhaust pipe 16.

Inside the exhaust pipe 16, the urea water injected by the injection unit 18 (FIG. 1) is evaporated and decomposed to generate ammonia gas. The exhaust pipe 16 is provided with a sensor attachment portion 20, an injection attachment portion 25, the upstream plate 30, the downstream plate 40, a conduit 45, a partition portion 50, and a guide plate 60. The upstream plate 30 and the downstream plate 40 are a pair of plate members that form an internal space in the exhaust pipe 16.

The sensor attachment portion 20 is a portion to which the NOx sensor 19 (FIG. 1) is attached. The sensor attachment portion 20 is provided on an outer peripheral surface of the exhaust pipe 16. As shown in FIG. 5, the sensor attachment portion 20 is located above the conduit 45 in an up-down direction (specifically, a vertical direction). The NOx sensor 19 attached to the sensor attachment portion 20 detects the concentration of NOx in the exhaust gas flowing through an internal space (specifically, a first region R1) of the exhaust pipe 16.

The injection attachment portion 25 is a portion to which the injection unit 18 is attached. The injection attachment portion 25 is formed on the outer peripheral surface of the exhaust pipe 16. The injection attachment portion 25 is formed at a position away from the sensor attachment portion 20 in a circumferential direction of the outer peripheral surface. The injection attachment portion 25 is located above the conduit 45 in the vertical direction. Further, the injection attachment portion 25 is located above the guide plate 60 in the vertical direction. The injection unit 18 attached to the injection attachment portion 25 injects urea water into an internal space (specifically, a second region R2) of the exhaust pipe 16. Specifically, the injection unit 18 injects urea water toward the guide plate 60 located in the second region R2.

The upstream plate 30 is a plate member disposed upstream of the injection unit 18 in the exhaust pipe 16. The upstream plate 30 is disposed upstream of the injection attachment portion 25 to which the injection unit 18 is attached. The upstream plate 30 is provided so as to be orthogonal to an axial direction (front-rear direction) of the exhaust pipe 16. The upstream plate 30 is a disk having a predetermined radius. The radius of the upstream plate 30 is the same as the inner diameter of the exhaust pipe 16. Therefore, an edge of the upstream plate 30 is in contact with an inner wall surface of the exhaust pipe 16.

The downstream plate 40 is a plate member disposed downstream of the injection unit 18 (specifically, the injection attachment portion 25) in the exhaust pipe 16. The downstream plate 40 is provided so as to be orthogonal to the axial direction (front-rear direction) of the exhaust pipe 16, and faces the upstream plate 30 with a predetermined spacing therebetween in the axial direction of the exhaust pipe 16. The downstream plate 40 is also a disk like the upstream plate 30, and an edge of the downstream plate 40 is in contact with the inner wall surface of the exhaust pipe 16.

The upstream plate 30 has an inflow hole for allowing exhaust gas to flow into a region surrounded by the upstream plate 30 and the downstream plate 40. For example, as shown in FIG. 3, the upstream plate 30 has a first inflow hole 32, a second inflow hole 33, a third inflow hole 34, a fourth inflow hole 35, and a fifth inflow hole 36. In the present embodiment, the first inflow hole 32 corresponds to a first opening, the fourth inflow hole 35 corresponds to a second opening, the third inflow hole 34 corresponds to a third opening, and the second inflow hole 33 corresponds to a fourth opening.

The first inflow hole 32 is a through hole formed in the center of the upstream plate 30. As shown in FIG. 4, the first inflow hole 32 is formed at a position closer to the center of the conduit 45 than an inner wall surface thereof. Therefore, the exhaust gas flowing in through the first inflow hole 32 travels in the conduit 45 along the axial direction. The diameter of the first inflow hole 32 is smaller than the inner diameter of the conduit 45. The first inflow hole 32 is circular here, and the center of the first inflow hole 32 is disposed on the central axis of the conduit 45.

The second inflow hole 33 is a through hole for allowing exhaust gas to flow into the first region R1 of the internal space. Specifically, the second inflow hole 33 allows exhaust gas to flow into the vicinity of the sensor attachment portion 20 to which the NOx sensor 19 is attached. Therefore, the NOx sensor 19 detects the concentration of NOx in the exhaust gas flowing in through the second inflow hole 33.

The third inflow hole 34 is a through hole disposed between the conduit 45 and the guide plate 60. Specifically, as shown in FIG. 5, the third inflow hole 34 is formed along the circumferential direction on the radially inner side of the guide plate 60. The third inflow hole 34 is formed in an arc shape along the guide plate 60, for example. The exhaust gas flowing in through the third inflow hole 34 flows between the conduit 45 and the guide plate 60 toward the inlet port 47 of the conduit 45 along a facing surface 62 of the guide plate 60 (see FIG. 6). That is, the exhaust gas flows while swirling between the conduit 45 and the guide plate 60. At this time, the exhaust gas causes ammonia gas generated from urea water to be directed toward the inlet port 47.

The fourth inflow hole 35 is a through hole disposed between the guide plate 60 and the inner wall surface of the exhaust pipe 16. Specifically, as shown in FIG. 5, the fourth inflow hole 35 is formed along the circumferential direction on the radially outer side of the guide plate 60. The fourth inflow hole 35 is formed in an arc shape along the guide plate 60, for example. The exhaust gas flowing in through the fourth inflow hole 35 flows between the guide plate 60 and the exhaust pipe 16 toward the inlet port 47 of the conduit 45 along a back surface 64 of the guide plate 60. That is, the exhaust gas flows while swirling between the guide plate 60 and the exhaust pipe 16. At this time, the exhaust gas heats the back surface 64 of the guide plate 60.

As shown in FIG. 6, the fifth inflow hole 36 is a through hole disposed radially outward of the inlet port 47 of the conduit 45 in the internal space. For example, the fifth inflow hole 36 is located on an imaginary line passing through the inlet port 47 from the central axis of the conduit 45. The exhaust gas flowing in through the fifth inflow hole 36 flows toward the inlet port 47 of the conduit 45. Thus, an amount of exhaust gas flowing into the conduit 45 can be increased.

The conduit 45 is provided in the internal space along the axial direction of the exhaust pipe 16. Specifically, the conduit 45 is provided in the center of the internal space along the axial direction. The inlet port 47 that introduces the exhaust gas in the internal space is formed in an outer peripheral surface of the conduit 45. The conduit 45 guides the exhaust gas flowing in through the inlet port 47 to the outside of the exhaust pipe 16. Specifically, the conduit 45 guides the exhaust gas to the downstream aftertreatment unit 14 (FIG. 1). It should be noted that the inlet port 47 introduces the ammonia gas into the conduit 45 together with the exhaust gas.

An end portion of the conduit 45 in the axial direction is in contact with the upstream plate 30. The upstream plate 30 closes an opening of the end portion of the conduit 45. The other end portion of the conduit 45 in the axial direction is inserted through the downstream plate 40 as shown in FIG. 2. A through hole is formed in the downstream plate 40, and the other end portion of the conduit 45 is inserted through the through hole. An outflow hole 48 through which the exhaust gas and the ammonia gas flow out is formed in the other end portion of the conduit 45. Therefore, the exhaust gas and the ammonia gas flowing in through the inlet port 47 flow out from the outflow hole 48 at the other end portion. The exhaust gas and the ammonia gas flowing out from the outflow hole 48 flow to the downstream aftertreatment unit 14 disposed downstream of the exhaust pipe 16.

The partition portion 50 divides the space in the exhaust pipe 16 into a plurality of regions. Specifically, as shown in FIG. 5, the partition portion 50 divides the circumference of the conduit 45 into a first region R1 and a second region R2 in the circumferential direction. Here, the first region R1 is a region surrounding the second inflow hole 33. The second region R2 is a region excluding the first region R1 around the conduit 45. Urea water is injected from the injection unit 18 into the second region R2, and urea water is not injected from the injection unit 18 into the first region R1.

As shown in FIG. 6, the partition portion 50 is formed with a communication port 56 for allowing the exhaust gas to move from the first region R1 to the second region R2. The communication port 56 is disposed between the sensor attachment portion 20 and the injection attachment portion 25 in the circumferential direction.

As shown in FIG. 2, the partition portion 50 includes a shielding plate 52 and a communication plate 54.

The shielding plate 52 is a first plate that separates the first region R1 and the second region R2 from each other. Here, the shielding plate 52 is a flat plate. The shielding plate 52 extends radially outward from the outer peripheral surface of the conduit 45, and is connected to the outer peripheral surface of the conduit 45 and the inner wall surface of the exhaust pipe 16. Further, the shielding plate 52 extends along the axial direction of the conduit 45. The shielding plate 52 is provided at a position adjacent to the inlet port 47 of the conduit 45. By providing the shielding plate 52, the exhaust gas flowing into the inlet port 47 along the guide plate 60 can be prevented from flowing into the first region R1.

The communication plate 54 is a second plate surrounding the first region R1 with the shielding plate 52. Here, the communication plate 54 is a flat plate, and is disposed at a position circumferentially spaced from the shielding plate 52 by a predetermined angle. The first region R1 is surrounded by the shielding plate 52, the communication plate 54, the upstream plate 30, the downstream plate 40, the outer peripheral surface of the conduit 45, and the inner wall surface of the exhaust pipe 16. The communication plate 54 also extends radially outward from the outer peripheral surface of the conduit 45, and is connected to the outer peripheral surface of the conduit 45 and the inner wall surface of the exhaust pipe 16. Further, the communication plate 54 extends along the axial direction of the conduit 45.

As shown in FIG. 2, a communication port 56 is formed in the communication plate 54. The communication port 56 is an opening penetrating the communication plate 54, and is formed in a central portion of the communication plate 54, for example. Here, the communication port 56 is a rectangular opening, but is not limited thereto. For example, the communication port 56 may be a plurality of circular openings. By forming the communication port 56, the exhaust gas whose concentration of NOx has been detected by the NOx sensor 19 smoothly flows into the second region R2.

By providing the partition portion 50, it is possible to prevent the urea water injected by the injection unit 18 from adhering to the NOx sensor 19 even when the NOx sensor 19 and the injection unit 18 are located at positions separated from each other in the circumferential direction of the exhaust pipe 16. Further, the NOx sensor 19 and the injection unit 18 can be close to each other in the axial direction, thereby reducing the length of the exhaust pipe 16 in the axial direction.

The guide plate 60 is a plate member that is provided in the second region R2 of the internal space, and guides the exhaust gas to the inlet port 47 of the conduit 45. The guide plate 60 is provided around the conduit 45. Specifically, the guide plate 60 is provided in the second region R2 along the outer peripheral surface of the conduit 45. A circumferential end portion of the guide plate 60 faces the inlet port 47 of the conduit 45. Accordingly, the exhaust gas in the second region R2 is guided by the guide plate 60, and flows toward the inlet port 47 while swirling around the conduit 45.

As shown in FIG. 5, the guide plate 60 is provided in the second region R2 so as to face the injection attachment portion 25 (in other words, the injection unit 18 attached to the injection attachment portion 25) disposed above the guide plate 60 in the vertical direction. The guide plate 60 has the facing surface 62 that faces the injection unit 18, and the urea water injected by the injection unit 18 adheres to the facing surface 62. The guide plate 60 is heated by the exhaust gas flowing around the guide plate 60. Therefore, the urea water adhering to the facing surface 62 is evaporated by the heat of the guide plate 60. Ammonia gas is generated by evaporation and decomposition of urea water. The generated ammonia gas is carried by the exhaust gas toward the inlet port 47, and is directed to the inside of the conduit 45 together with the exhaust gas.

As shown in FIG. 2, the guide plate 60 is disposed between the upstream plate 30 and the downstream plate 40 in the axial direction of the exhaust pipe 16. Both end portions of the guide plate 60 in the axial direction are in contact with the upstream plate 30 and the downstream plate 40. A cross-sectional shape of the guide plate 60 in a plane orthogonal to the axial direction is an arc shape. Therefore, the facing surface 62 of the guide plate 60 is a curved surface having a predetermined curvature. The guide plate 60 surrounds half or more of the outer peripheral surface of the conduit 45 in the circumferential direction. In this case, since an area of the facing surface 62 to which urea water adheres is increased, evaporation of urea water can be effectively performed.

The back surface 64 of the guide plate 60 opposite to the facing surface 62 is separated from the inner wall surface of the exhaust pipe 16. A space through which the exhaust gas flowing in through the fourth inflow hole 35 flows is formed between the back surface 64 and the inner wall surface of the exhaust pipe 16. The exhaust gas flowing in through the fourth inflow hole 35 flows along the back surface 64 of the guide plate 60. Specifically, the exhaust gas flows toward the inlet port 47 of the conduit 45 while swirling along the back surface 64. At this time, the back surface 64 is heated by the heat of the exhaust gas. This facilitates evaporation of the urea water adhering to the facing surface 62 of the guide plate 60 by the heat of the guide plate 60 heated by the exhaust gas.

As shown in FIG. 2, the guide plate 60 has bent portions 66 formed by bending both end portions of the guide plate 60 in the axial direction. The bent portions 66 are bent toward the conduit 45. The bent portion 66 on one end portion in the axial direction is in contact with the upstream plate 30, and the bent portion 66 on the other end portion in the axial direction is in contact with the downstream plate 40. Providing such bent portions 66 allows the guide plate 60 to easily accumulate urea water on the facing surface 62.

As described above, the third inflow hole 34 of the upstream plate 30 is formed along the circumferential direction on the radially inner side of the guide plate 60. In this case, there is a possibility that, depending on the position of the third inflow hole 34, the urea water accumulated on the guide plate 60 falls from the third inflow hole 34 onto the inner wall surface of the exhaust pipe 16.

In contrast, in the present embodiment, the third inflow hole 34 is formed along the circumferential direction at a position radially inward of the bent portions 66, as shown in FIG. 5. In this case, the bent portions 66 can restrict the urea water accumulated on the facing surface 62 from moving toward the third inflow hole 34, thereby preventing the urea water from falling onto the inner wall surface of the exhaust pipe 16 through the third inflow hole 34.

The conduit 45 is not positioned on the central axis of the exhaust pipe 16. The central axis of the conduit 45 is positioned on a side opposite to the injection attachment portion 25 (in other words, the injection unit 18) as viewed from a vertical line L (FIG. 5) passing through the central axis of the exhaust pipe 16. Even when the guide plate 60 is located around the conduit 45, the conduit 45 is offset in a direction away from the injection unit 18, which allows the urea water injected by the injection unit 18 to easily adhere to the guide plate 60.

The urea water injection direction of the injection unit 18 may be inclined in a direction away from the central axis of the conduit 45 with respect to the vertical line passing through the injection unit 18. That is, the injection unit 18 injects urea water obliquely downward. In this case, as compared with the case where the injection unit 18 injects urea water downward, urea water is more easily caused to adhere to a wide area of the facing surface 62, which is the curved surface of the guide plate 60, thereby enabling efficient evaporation of urea water.

### Effects of Embodiment

The exhaust treatment device 1 of the above-described embodiment includes i) the upstream plate 30 and the downstream plate 40 that form the internal space in the exhaust pipe 16, ii) the conduit 45 that is provided along the axial direction in the internal space, and guides the exhaust gas introduced from the inlet port 47 formed on the outer peripheral surface to the outside of the exhaust pipe 16, iii) the partition portion 50 that divides the circumference of the conduit 45 into the first region R1 and the second region R2 in the circumferential direction, and in which the communication port 56 that allows exhaust gas to move from the first region R1 to the second region R2 is formed, and iv) the guide plate 60 that is provided in the second region R2 along the outer peripheral surface of the conduit 45, and guides the exhaust gas to the inlet port 47. Further, the exhaust treatment device 1 includes the NOx sensor 19 that detects the concentration of NOx in the exhaust gas in the first region R1, and the injection unit 18 that injects urea water toward the guide plate 60 in the second region R2.

Of the first region R1 and the second region R2 divided by the partition portion 50, the NOx sensor 19 is disposed in the first region R1 and the injection unit 18 is disposed in the second region R2, thereby preventing the urea water injected by the injection unit 18 from adhering to the NOx sensor 19. In addition, since the communication port 56 that allows exhaust gas to move from the first region R1 to the second region R2 is formed in the partition portion 50, the exhaust gas in which the concentration of NOx has been detected is directed to the second region R2 in which the guide plate 60 is provided, thereby promoting evaporation and decomposition of the urea water adhering to the guide plate 60.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. An exhaust treatment device comprising:
an exhaust pipe through which exhaust gas flows;
a pair of plate members that are provided to face each other with a predetermined spacing therebetween in an axial direction of the exhaust pipe, and form a space in the exhaust pipe;
a conduit that is provided in the space along the axial direction, and guides exhaust gas introduced from an inlet port formed in an outer peripheral surface to the outside of the exhaust pipe;
a partition portion that divides a circumference of the conduit into a first region and a second region in a circumferential direction, and in which a communication port that allows exhaust gas to move from the first region to the second region is formed;
a guide plate that is provided in the second region along an outer peripheral surface of the conduit, and guides exhaust gas to the inlet port;
a NOx sensor that detects concentration of NOx in exhaust gas in the first region; and
an injection unit that injects urea water toward the guide plate in the second region.

2. The exhaust treatment device according to claim 1, wherein
the partition portion includes:
a first plate that is connected to the outer peripheral surface of the conduit and an inner wall surface of the exhaust pipe, and separates the first region and the second region from each other, and
a second plate that surrounds the first region with the first plate, and in which the communication port is formed.

3. The exhaust treatment device according to claim 1, wherein
a central axis of the conduit is positioned on a side opposite to the injection unit when viewed from a vertical line passing through a central axis of the exhaust pipe.

4. The exhaust treatment device according to claim 3, wherein
an injection direction of the urea water of the injection unit is inclined in a direction away from the central axis of the conduit with respect to a vertical line passing through the injection unit.

5. The exhaust treatment device according to claim 3, wherein
the guide plate surrounds half or more of the outer peripheral surface of the conduit in the circumferential direction.

6. The exhaust treatment device according to claim 1, wherein
an upstream plate member disposed upstream of the pair of plate members further includes a first opening formed at a position closer to a center of the conduit than an inner wall surface thereof.

7. The exhaust treatment device according to claim 1, wherein
an upstream plate member disposed upstream of the pair of plate members has a second opening formed along a circumferential direction on a radially outer side of the guide plate.

8. The exhaust treatment device according to claim 1, wherein
the guide plate has bent portions that are bent toward the conduit at both ends in the axial direction.

9. The exhaust treatment device according to claim 8, wherein
an upstream plate member disposed upstream of the pair of plate members has a third opening formed along a circumferential direction at a position radially inward of the bent portions.

10. The exhaust treatment device according to claim 1, wherein
an upstream plate member disposed upstream of the pair of plate members has a fourth opening for allowing exhaust gas to flow into the first region.
